(19) United States
(12) Patent Application Publication
(10) Pub. No.: US 2024/0100658 A1
(43) Pub. Date: Mar. 28, 2024

(54) POWERED RATCHET

(71) Applicant: TECHTRONIC CORDLESS GP, Anderson, SC (US)

(72) Inventors: Austin Clark, Seneca, SC (US); Carl N. Chandler, Greenville, SC (US); Matthew Samstag, Belton, SC (US); Joshua Collins, Easley, SC (US); James W. Jenkins, Anderson, SC (US); Ryan Altenburger, Greenville, SC (US); Gui Fang Zhou, Dongguan City (CN); Yu Zhao, Dongguan City (CN); Ping Zhang, Dongguan City (CN)

(21) Appl. No.: 18/264,321

(22) PCT Filed: Feb. 18, 2022
(86) PCT No.: PCT/CN2022/076926

§ 371 Date: Aug. 4, 2023

Related U.S. Application Data
(60) Provisional application No. 63/154,046, filed on Feb. 26, 2021.

(51) Int. Cl. B25B 21/00; B25F 5/00

(52) U.S. Cl. CPC B25B 21/004; B25F 5/001

(57) ABSTRACT

A powered ratchet includes a motor, a mounting portion, and an output member configured to rotate in response to activation of the motor. The output member defines a drive axis. The powered ratchet also includes a release mechanism configured to selectively couple an anvil to the output member. The release mechanism includes a cover coupled to the mounting portion with a track and a locking member positioned between the mounting portion and the cover and operable to slide within the track between a locked position, in which the locking member engages the anvil to secure the anvil to the output member for co-rotation therewith, and a release position, in which the locking member is disengaged from the anvil to facilitate removal of the anvil. The release mechanism also includes a biasing member biasing the locking member to the locked position.

### CROSS REFERENCE TO RELATED APPLICATION

This application claims the benefit of co-pending U.S. Provisional Patent Application No. 63/154,046, filed on Feb. 26, 2021, the entire content of which is incorporated herein by reference.

### FIELD OF THE DISCLOSURE

The present disclosure relates to power tools, and more particularly to powered ratchets.

### BACKGROUND OF THE DISCLOSURE

Powered ratchets are used to rotate sockets to loosen or tighten a fastener. Such powered ratchets typically include a motor that provides torque to an anvil, to which a socket is attachable. Powered ratchets also typically include a reversing mechanism to switch the rotational direction of the anvil and socket.

### SUMMARY OF THE DISCLOSURE

The present disclosure provides, in one aspect, a powered ratchet including a motor, a mounting portion, and an output member configured to rotate in response to activation of the motor. The output member defines a drive axis. The powered ratchet also includes a release mechanism configured to selectively couple an anvil to the output member. The release mechanism includes a cover coupled to the mounting portion with a track and a locking member positioned between the mounting portion and the cover and operable to slide within the track between a locked position, in which the locking member engages the anvil to secure the anvil to the output member for co-rotation therewith, and a release position, in which the locking member is disengaged from the anvil to facilitate removal of the anvil. The release mechanism also includes a biasing member biasing the locking member to the locked position.

The present disclosure provides, in another aspect, a powered ratchet including a motor and an output member configured to rotate in response to activation of the motor. The output member defines a drive axis. The powered ratchet also includes a release mechanism configured to selectively couple an anvil to the output member. The release mechanism includes a locking member that is pivotable between a locked position, in which the locking member engages the anvil to secure the anvil to the output member for co-rotation therewith, and a release position, in which the locking member is disengaged from the anvil to facilitate removal of the anvil from the output member. The release mechanism also includes a slider that is moveable between a forward position, in which the slider locks the locking member in the locked position, and a rearward position, in which the locking member is allowed to pivot between the locked position and the release position. The release mechanism further includes a biasing member configured to bias the slider to the forward position

The present disclosure provides, in another aspect, a powered ratchet including a motor and an output member configured to rotate in response to activation of the motor, the output member defining a drive axis. The powered ratchet also includes a release mechanism configured to selectively couple an anvil to the output member. The release mechanism includes a resilient locking member moveable between a locked position in which the locking member engages the anvil to secure the anvil to the output member for co-rotation therewith, and a release position, in which the locking member is disengaged from the anvil to facilitate removal of the anvil from the output member. The release mechanism also includes an actuator coupled to the locking member to move the locking member between the locked position and the release position.

The present disclosure provides, in another aspect, a powered ratchet including a motor, a yoke defining a central opening and rotatable in a reciprocating manner in response to torque received from the motor and an output member operable to rotate in response to activation of the motor. The output member is positioned within the central opening. The output member defines a drive axis. The powered ratchet also includes a cage positioned between the yoke and the output member. The cage includes a plurality of openings, each opening configured to receive a roller. The powered ratchet further includes a reversing mechanism with a sliding actuator moveable between a first position, in which the output member rotates in a first direction in response to reciprocating motion of the yoke, and a second position, in which the output member rotates in a second direction opposite the first direction in response to reciprocating motion of the yoke.

The present disclosure provides, in another aspect, a powered ratchet including a motor, a yoke defining a central opening and rotatable in a reciprocating manner in response to torque received from the motor and an output member operable to rotate in response to activation of the motor. The output member is positioned within the central opening. The output member defines a drive axis. The powered ratchet also includes a cage positioned between the yoke and the output member. The cage includes a plurality of openings, each opening configured to receive a roller. The powered ratchet further includes a reversing mechanism with an actuator that is pivotable about a pivot axis that is perpendicular to the drive axis between a first position, in which the output member rotates in a first direction in response to reciprocating motion of the yoke, and a second position, in which the output member rotates in a second direction opposite the first direction in response to reciprocating motion of the yoke.

The present disclosure provides, in another aspect, a reversible anvil for use with a powered ratchet. The anvil includes a first socket adapter defined on a first end. The first socket adapter is configured to receive a socket of a first size. The reversible anvil also includes a second socket adapter defined on a second end opposite the first end. The second socket adapter is configured to receive a socket of a second size that is different from the first size.

The present disclosure provides, in another aspect, a powered ratchet including a motor, a yoke defining a central opening and rotatable in a reciprocating manner in response to torque received from the motor, and an output member operable to rotate in response to activation of the motor. The output member is positioned within the central opening and defines a drive axis. The powered ratchet also includes a cage positioned between the yoke and the output member. The cage includes a plurality of openings, each opening configured to receive a roller. The powered ratchet also includes a reversing mechanism with an actuator that is pivotable about a pivot axis between a first position, in which the output member rotates in a first direction in response to reciprocating motion of the yoke, and a second position, in which the output member rotates in a second direction opposite the first direction in response to reciprocating motion of the yoke. The powered ratchet further includes a release mechanism configured to selectively couple an anvil to the output member. The release mechanism includes a locking member operable to slide between a locked position, in which the locking member engages the anvil to secure the anvil to the output member for co-rotation therewith, and a release position, in which the locking member is disengaged from the anvil to facilitate removal of the anvil and a biasing member biasing the locking member to the locked position.

### BRIEF DESCRIPTION OF THE DRAWINGS

FIG. 1 is a perspective view of a powered ratchet.

FIG. 2 is a bottom perspective view of a ratcheting drive unit of the powered ratchet of FIG. 1.

FIG. 3 is a top perspective view of the ratcheting drive unit of FIG. 2.

FIG. 4 is an exploded view of the ratcheting drive unit of FIG. 2.

FIG. 5 is a top view of the ratcheting drive unit of FIG. 2 with a reversing mechanism in a neutral position.

FIG. 6 is a top view of the ratcheting drive unit of FIG. 2 with the reversing mechanism in a forward position.

FIG. 7 is a top view of the ratcheting drive unit of FIG. 2 with the reversing mechanism in a rearward position.

FIG. 8 is a bottom perspective view of the ratcheting drive unit of FIG. 2 with an anvil release mechanism in a locked position.

FIG. 9 is a bottom perspective view of the ratcheting drive unit of FIG. 2 with the anvil release mechanism in an intermediate position.

FIG. 10 is a bottom perspective view of the ratcheting drive unit of FIG. 2 with the anvil release mechanism in a release position.

FIG. 11 is a perspective view of an anvil for use with the powered ratchet of FIG. 1.

FIG. 12 is another perspective view of the anvil of FIG. 11.

FIG. 13 is a perspective view of another embodiment of a reversing mechanism for use with the powered ratchet of FIG. 1.

FIG. 14 is a bottom perspective view of another embodiment of an anvil release mechanism for use with the powered ratchet of FIG. 1, illustrating the anvil release mechanism in a locked position.

FIG. 15 is a bottom perspective of the anvil release mechanism of FIG. 14 in a release passion.

FIG. 16 is a perspective view of another embodiment of a reversing mechanism for use with the powered ratchet of FIG. 1.

FIG. 17 is a perspective view of another embodiment of an anvil release mechanism for use with the powered ratchet of FIG. 1.

FIG. 18 is a perspective view of the anvil release mechanism of FIG. 17 with portions removed.

FIG. 19 is a plan view of the anvil release mechanism of FIG. 18.

FIG. 20 is a perspective view of a drive unit for use with the powered ratchet of FIG. 1.

FIG. 21 is an exploded view of the drive unit of FIG. 20.

FIG. 22 is a plan view of a portion of a reversing mechanism for use with the drive unit of FIG. 20.

FIG. 23 is a perspective view of a portion of a reversing mechanism for use with the drive unit of FIG. 20.

FIG. 24 is a perspective view of an anvil release mechanism for use with the drive unit of FIG. 20.

FIG. 25 is a cross-sectional view of the drive unit of FIG. 20.

FIG. 26 is a perspective view of another embodiment of a reversing mechanism for use with the powered ratchet of FIG. 1.

FIG. 27 is an exploded view of the reversing mechanism of FIG. 26.

FIG. 28 is a perspective view of the reversing mechanism of FIG. 26 with portions removed.

Before any embodiments of the disclosure are explained in detail, it is to be understood that the disclosure is not limited in its application to the details of construction and the arrangement of components set forth in the following description or illustrated in the following drawings. Also, it is to be understood that the phraseology and terminology used herein is for the purpose of description and should not be regarded as limiting.

### DETAILED DESCRIPTION

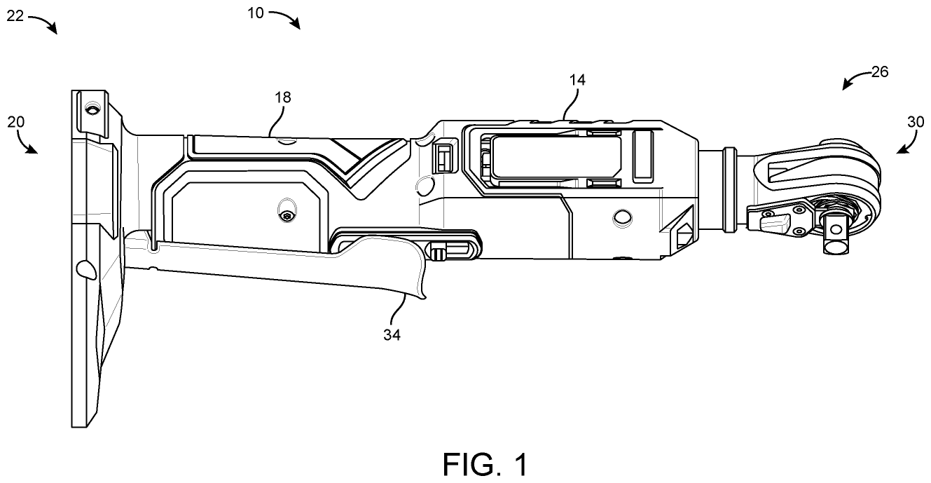

FIG. 1 illustrates a powered ratchet 10 that may be used to tighten or loosen fasteners with a socket (not shown) attachable to the ratchet 10. The powered ratchet 10 includes a housing 14 defining a grip 18, a motor (not shown) positioned within the housing 14, a battery receptacle 20 at a first end 22 of the housing 14 that is configured to receive a battery pack (not shown), and a ratcheting drive unit 26 at a second end 30 of the housing 14 opposite the first end 22. A trigger 34 extends from the housing 14 and is depressed by a user to activate the motor.

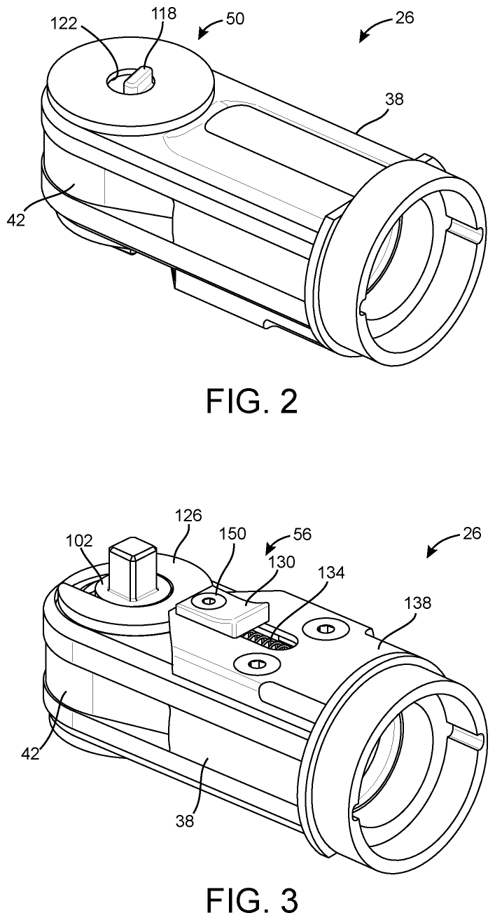

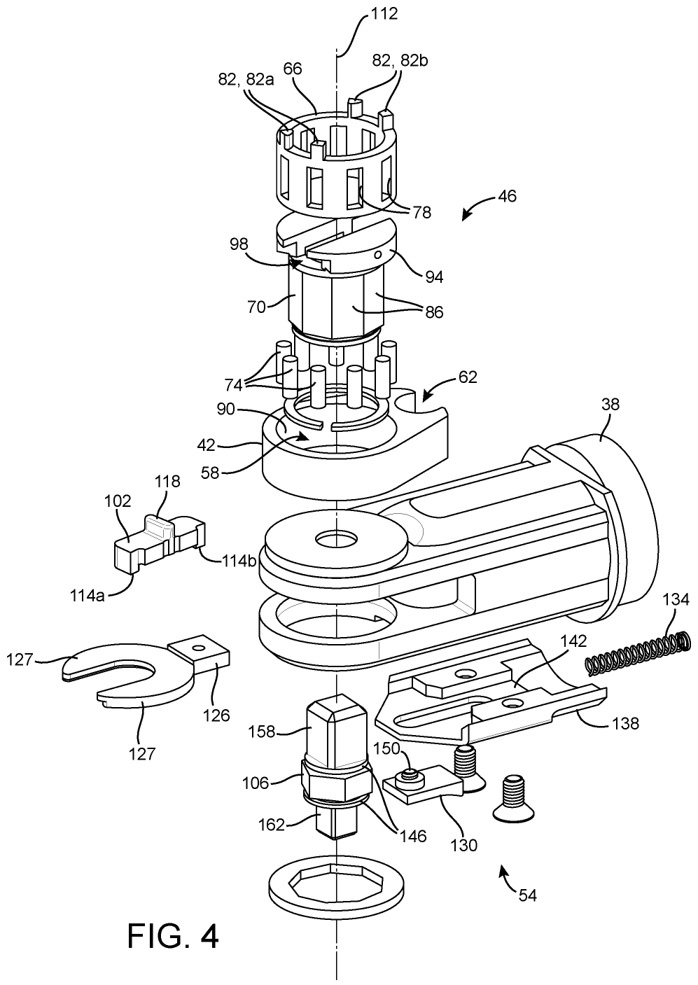

With reference to FIGS. 2-4, the drive unit 26 includes a mounting portion 38 coupled to the housing 14, a yoke 42, a one-way clutch mechanism 46, a reversing mechanism 50, and an anvil release mechanism 54. With reference to FIG. 4, the yoke 42 includes a central opening 58 and a recess 62 that receives an eccentric pin of a drive shaft (not shown) that receives torque from the motor. The rotating drive shaft causes the eccentric pin to oscillate the yoke 42 in a circumferential direction.

With continued reference to FIG. 4, the clutch mechanism 46 includes a cage 66, an output member (i.e., a barrel 70), and a plurality of cylindrical lock pins (i.e., rollers 74). The cage 66, the barrel 70, and the rollers 74 are all rotatably supported within the central opening 58 of the yoke 42. The cage 66 is supported around the barrel 70 and includes a plurality of openings 78 and a plurality of posts 82 extending from a top end of the cage 66. The openings 78 rotatably support the rollers 74 between surfaces 86 of the barrel 70 and an inner surface 90 of the yoke 42. In the illustrated embodiment, the surfaces 86 are generally planar or polygonal and the inner surface 90 is generally cylindrical. The barrel 70 includes a top portion 94 with a slot 98 to receive a sliding actuator 102 of the reversing mechanism 50, as will be described in more detail below. The barrel 70 also includes a bore (not shown) in a bottom portion thereof to receive an anvil 106. The anvil 106 includes a biased ball detent (not shown) that secures the anvil 106 within the bore. The anvil 106 is configured to retain a socket for co-rotation therewith.

When the yoke 42 is oscillated, the rollers 74 allow the cage 66 to rotate relative to the barrel 70 in a slip direction. However, due to the oscillating movement of the yoke 42, when the cage 66 rotates in a drive direction opposite the slip direction, the rollers 74 engage the surfaces 86 of the barrel 70, preventing the cage 66 from rotating relative to the barrel 70 and allowing the yoke 42 to drive the barrel 70 and thus the anvil 106 in the drive direction to loosen or tighten a fastener.

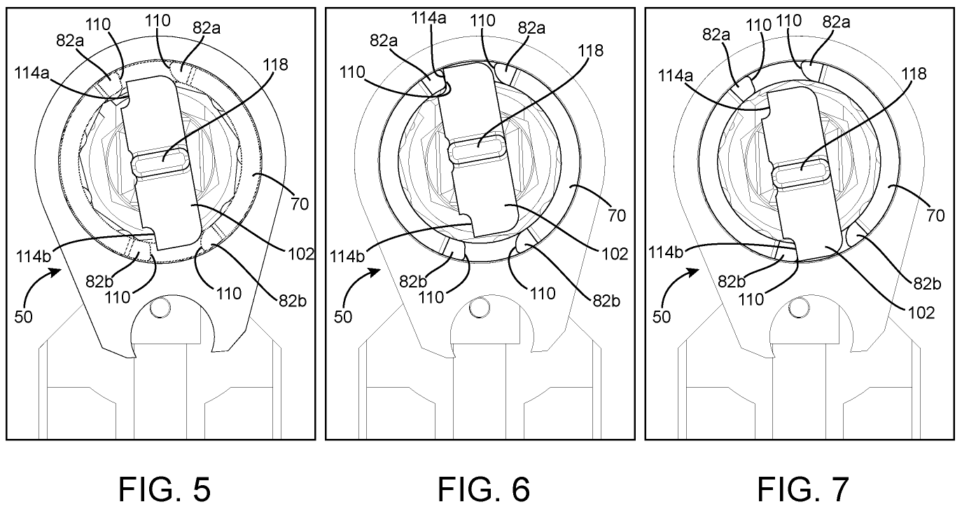

With continued reference to FIG. 4, the reversing mechanism 50 includes the cage 66, the barrel 70, and the sliding actuator 102. The cage 66 includes a first pair of posts 82a and a second pair of posts 82b on a diametrically opposite side of the cage 66 as the first pair of posts 82a. Each post 82 includes a cam surface 110 (FIG. 5) that faces the other post 82 in the pair of posts 82a, 82b. In other words, the cam surfaces 110 on each of the first pair of posts 82a face each other and the cam surfaces 110 on each of the second pair of posts 82b face each other. The sliding actuator 102 is movable within the slot 98 of the barrel 70 in a linear direction that is perpendicular to a drive axis 112 of the barrel 70. The sliding actuator 102 includes two cam surfaces (i.e., a leading cam surface 114a and a trailing cam surface 114b) and a protrusion 118 (see also FIG. 4). The cam surfaces 114a, 114b of the sliding actuator 102 are operable to engage the cam surfaces 110 of the posts 82 to rotate the cage 66 relative to the barrel 70. In the illustrated embodiment, the leading cam surface 114a and the trailing cam surface 114b are positioned on the same longitudinal side of the sliding actuator 102. The protrusion 118 extends through an opening 122 (FIG. 2) in the mounting portion 38 to allow access to a user to engage the sliding actuator 102.

As shown in FIGS. 5-7, the reversing mechanism 50 is operable to switch the slip and drive directions of the clutch mechanism 46 between clockwise and counterclockwise directions. The sliding actuator 102 is moveable between a neutral position (FIG. 5), a forward position (FIG. 6), in which the drive direction is clockwise, and a reverse position (FIG. 7), in which the drive direction is counterclockwise. In the neutral position, the cam surfaces 114a, 114b of the sliding actuator 102 are not engaged with the cam surfaces 110 of the posts 82. As such, the rollers 74 do not engage the inner surface 90 of the yoke 42 or the surfaces 86 of the barrel 70, allowing the barrel 70 to freely rotate both in a clockwise direction and a counterclockwise direction. To tighten a fastener, a user may slide the sliding actuator 102 to the forward position. The leading cam surface 114a engages one of the cam surfaces 110 of the first pair of posts 82a, causing the cage 66 to rotate counterclockwise a small amount relative to the barrel 70 to position the rollers 74 adjacent a trailing end of the surfaces 86 (in a counterclockwise direction). In the forward position, when the yoke 42 rotates in a clockwise (drive) direction, the rollers 74 engage the inner surface 90 of the yoke 42 and the surfaces 86 of the barrel 70 to drive the barrel 70, and thus the anvil 106, in a clockwise direction to tighten a fastener. When the yoke 42 rotates in a counterclockwise (slip) direction, the rollers 74 slip along the surfaces 86 of the barrel 70, allowing the cage 66 to rotate relative to the barrel 70 without transferring torque to the anvil 106.

To loosen a fastener, a user may slide the sliding actuator 102 to the rearward position (FIG. 7). The trailing cam surface 114b engages one of the cam surfaces 110 of the second pair of posts 82b, causing the cage 66 to rotate clockwise a small amount relative to the barrel 70 to position the rollers 74 adjacent a leading end of the surfaces 86. In the rearward position, when the yoke 42 rotates in a counterclockwise (drive) direction, the rollers 74 engage the inner surface 90 of the yoke 42 and the surfaces 86 of the barrel 70 to drive the barrel 70, and thus the anvil 106, in a counterclockwise direction to loosen a fastener. When the yoke 42 rotates in a clockwise (slip) direction, the rollers 74 slip along the surfaces 86 of the barrel 70, allowing the cage 66 to rotate relative to the barrel 70 without transferring torque to the anvil 106.

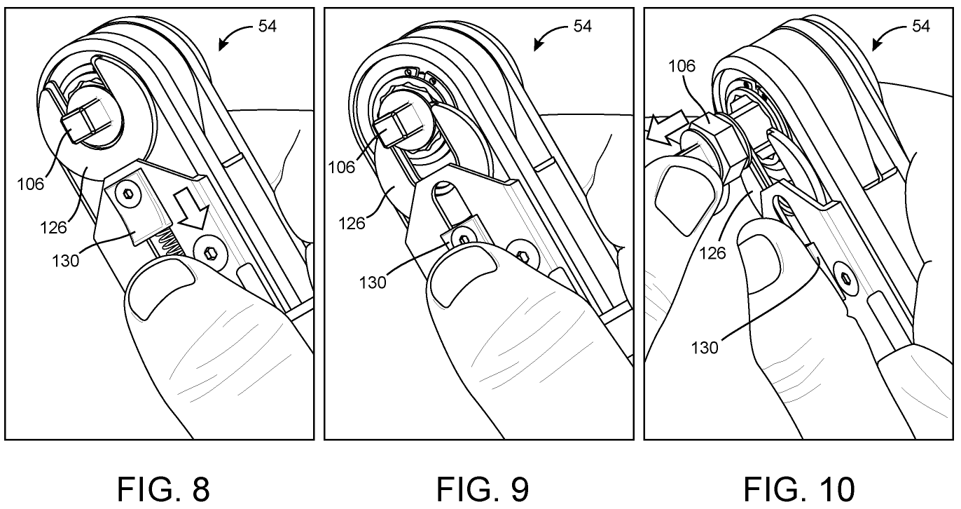

With reference back to FIGS. 3 and 4, the anvil release mechanism 54 includes a locking member (e.g., a fork 126), a slide actuator 130, a biasing member (e.g., a compression spring 134), and a cover 138. The fork 126 includes two arcuately-shaped prongs 127 that define an opening 128 therebetween. In the illustrated embodiment, the two prongs and the opening are arcuately shaped. The fork 126 is slidably supported within a track 142 in the cover 138 and extends from the cover 138 to engage one of two grooves 146 in the anvil 106. The slide actuator 130 is secured to the fork 126 with a fastener 150 that extends through a slot 154 in the cover 138. The compression spring 134 biases the slide actuator 130 to a locked position (FIG. 8), in which the fork 126 engages one of the grooves 146 in the anvil 106 to secure the anvil 106 to the barrel 70 for co-rotation therewith.

As shown in FIGS. 8-10, a user may push the slide actuator 130 against the bias of the compression spring 134 to a release position (FIG. 10), in which the fork 126 is removed from the groove 146 and the anvil 106 is removable from the bore of the barrel 70. As a user pushes the slide actuator 130, the fork 126 is withdrawn from the groove 146 allowing the anvil 106 to be removed from the bore. In the illustrated embodiment, the anvil 106 includes a first socket adapter 158 and a second socket adapter 162 (FIG. 4). The first socket adapter 158 may be configured to receive a socket of a first size and the second socket adapter 162 may be configured to receive a socket of a second size that is different from the first size. For example, the first socket adapter 158 may receive a ⅜″ socket and the second socket adapter 162 may receive a ¼″ socket. In other embodiments, the first and second socket adapters 158, 162 may receive sockets of other sizes.

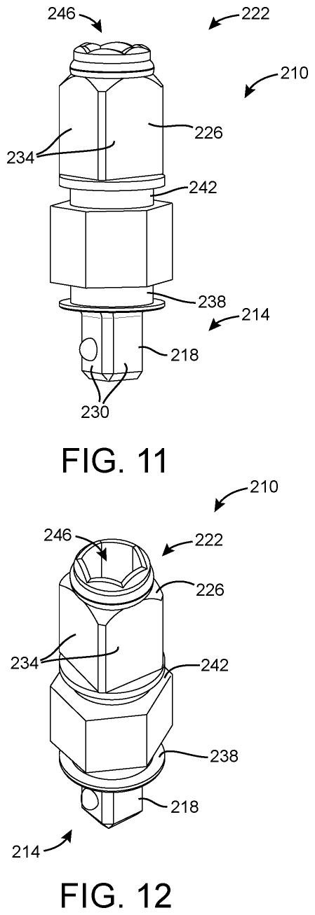

FIGS. 11 and 12 illustrate another embodiment of an anvil 210 that is usable with the powered ratchet 10 of FIG. 1. The anvil 210 includes a first end 214 with a first socket adapter 218 and a second end 222 opposite the first end 214 with a second socket adapter 226. The first socket adapter 218 includes a plurality of first orthogonal faces 230 that are adapted to receive a socket of a first size. The second socket adapter 226 includes a plurality of second orthogonal faces 234 that are adapted to receive a socket of a second size. The anvil 210 includes a first groove 238 and a second groove 242 in which the fork 126 may be received to secure the anvil 210 to the barrel 70. As such, the anvil 210 is reversible so that a user may remove the anvil 210 and flip it to use a socket adapter of a different size. A hex-shaped opening 246 is defined in the second end 222 of the anvil 210. The hex-shaped opening 246, for example, may be used to directly drive ¼-inch tool bits (e.g., screwdriver bits, hex bits, TORX bits, etc.). And, if the fastener has a ¼-inch head, the opening 246 may be used to directly drive such fasteners to tighten or loosen the fasteners. In the illustrated embodiment, the hex-shaped opening 246 is configured to receive a ¼″ fastener. In other embodiments, the hex-shaped opening 246 may be configured to receive fasteners of different sizes. In further embodiments, the hex-shaped opening 246 may be configured to receive an extension for another socket adapter.

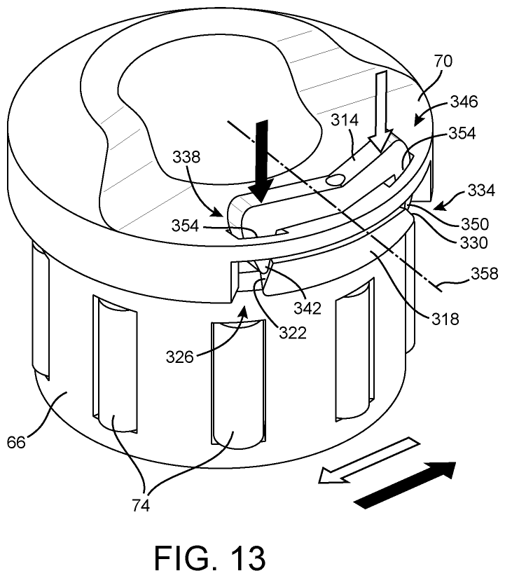

FIG. 13 illustrates another embodiment of a reversing mechanism 310. The reversing mechanism 310 is similar to the reversing mechanism 50 with like features being identified with like reference numbers. The reversing mechanism 310 includes the cage 66, the barrel 70, and the plurality of rollers 74. However, the reversing mechanism 310 includes a pivoting actuator 314. In the illustrated embodiment, the cage 66 includes a lip 318 having a first cam surface 322 at a first end 326 and second cam surface 330 at a second end 334. The pivoting actuator 314 includes a first end 338 that defines a first cam surface 342 and a second end 346 opposite the first end 338 that defines a second cam surface 350. The first and second ends 338, 346 of the pivoting actuator 314 extend through openings 354 in the barrel 70 so that the first and second cam surfaces 342, 350 may engage the first and second cam surfaces 322, 330 of the lip 318. The pivoting actuator 314 is seated on the barrel 70 so that it may pivot about a pivot axis 358.

Similar to the reversing mechanism 50, the pivoting actuator 314 engages the lip 318 of the cage 66 to rotate the cage 66 relative to the barrel 70 to change the slip and drive directions between clockwise and counterclockwise rotational directions. The pivoting actuator 314 is moveable between a forward position, in which the drive direction is clockwise, a reverse position, in which the drive direction is counterclockwise, and a neutral position. To tighten a fastener, a user may pivot the pivoting actuator 314 to the forward position. The first cam surface 342 of the pivoting actuator 314 engages the first cam surface 322 of the lip 318 causing the cage 66 to rotate counterclockwise a small amount relative to the barrel 70 to position the rollers 74 adjacent a trailing end of the surfaces 86. In the forward position, when the yoke 42 rotates in a clockwise direction, the rollers 74 engage the inner surface 90 of the yoke 42 and the surfaces 86 of the barrel 70 to drive the barrel 70, and thus the anvil 106, in a clockwise direction to tighten a fastener. When the yoke 42 rotates in a counterclockwise direction, the rollers 74 slip along the surfaces 86 of the barrel 70, allowing the cage 66 to rotate relative to the barrel 70 without transferring torque to the anvil 106.

To loosen a fastener, a user may pivot the pivoting actuator 314 to the reverse position. The second cam surface 350 of the pivoting actuator 314 engages the second cam surface 330 of the lip 318, causing the cage 66 to rotate clockwise a small amount relative to the barrel 70 to position the rollers 74 adjacent a leading end of the surfaces 86. In the reverse position, when the yoke 42 rotates in a counterclockwise direction, the rollers 74 engage the inner surface 90 of the yoke 42 and the surfaces 86 of the barrel 70 to drive the barrel 70, and thus the anvil 106 in a counterclockwise direction to loosen a fastener. When the yoke 42 rotates in a clockwise direction, the rollers 74 slip along the surfaces 86 of the barrel 70. allowing the cage 66 to rotate relative to the barrel 70 without transferring torque to the anvil 106.

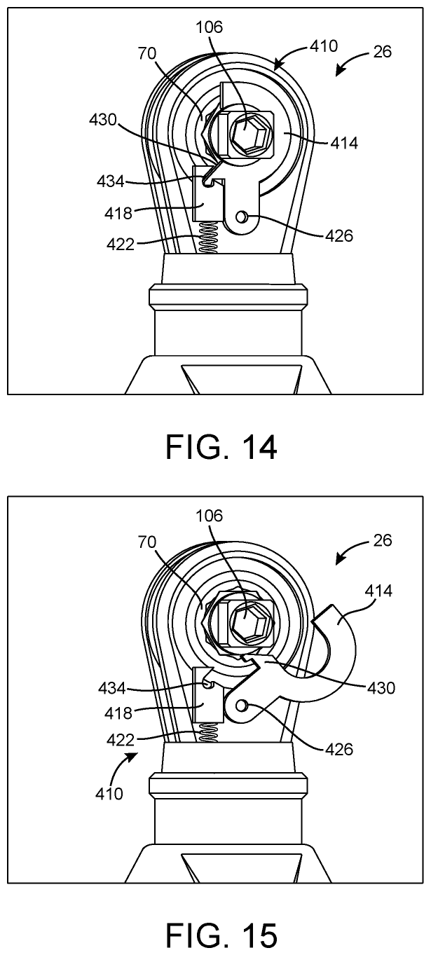

FIGS. 14 and 15 illustrate another embodiment of an anvil release mechanism 410 for use with the powered ratchet 10. The anvil release mechanism 410 includes a locking member (e.g., an arcuate fork 414), a slider 418, and a biasing member (e.g., a compression spring 422) that biases the slider 418 to a forward position (FIG. 14). The fork 414 is rotatable about a pivot axis 426 to engage and disengage one of the two grooves 146 in the anvil 106. The fork 414 includes a tang 430 that corresponds to a recess 434 defined within the slider 418. The slider 418 is moveable from the forward position, in which the tang 430 is received in the recess 434 to inhibit rotation of the fork 414 about the pivot axis 426, to a rearward position (FIG. 15), in which the tang 430 is not engaged with the recess 434 allowing the fork 414 to rotate about the pivot axis 426. In some embodiments, the slider 418 may include an actuator (similar to the slide actuator 130) to facilitate moving the slider 418 against the bias of the spring 422. In the illustrated embodiment, the slider 418 moves linearly from the forward position to the rearward position.

When the slider 418 is in the rearward position, the fork 414 is rotatable about the pivot axis 426 from a locked position (FIG. 14), in which the fork 414 engages one of the grooves 146 of the anvil 106 to secure the anvil 106 to the barrel 70, to a release position (FIG. 15), in which the fork 414 is not engaged with one of the grooves 146 of the anvil 106 allowing the anvil 106 to be removed from the bore of the barrel 70. In some embodiments, the fork 414 may be biased to the locked position by a biasing member. In other embodiments, the fork 414 may be biased to the release position by a biasing member.

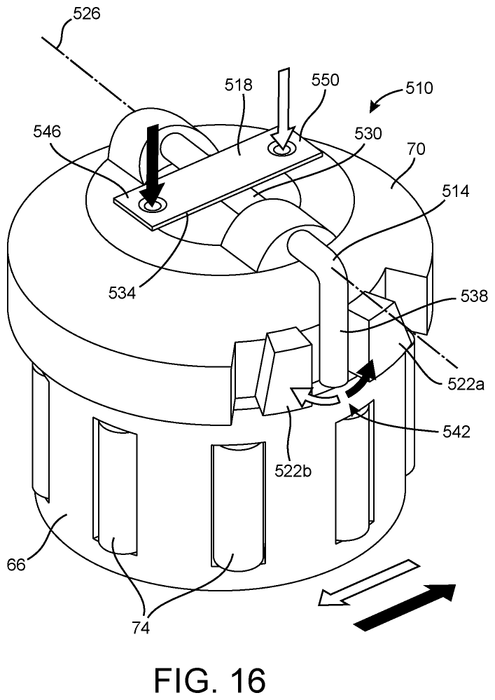

FIG. 16 illustrates another embodiment of a reversing mechanism 510. The reversing mechanism 510 is similar to the reversing mechanism 50 with like features being identified with like reference numbers. The reversing mechanism 510 includes the cage 66, the barrel 70, and the plurality of rollers 74. However, the reversing mechanism 510 includes a pivoting bar 514 and an actuator plate 518. In the illustrated embodiment, the cage 66 includes two projections 522a, 522b that extend from a top surface. The pivoting bar 514 is pivotably supported by the barrel 70 about a pivot axis 526. The pivoting bar 514 is L-shaped and includes a first portion 530 that extends over an opening 534 in the barrel 70 and a second portion 538 that extends into an opening 542 between the two projections 522a, 522b. The actuator plate 518 is coupled to the first portion 530 of the pivoting bar 514 for pivotal movement therewith. The actuator plate 518 is centrally positioned on the pivoting bar 514 and includes a first end 546 and a second end 550 opposite the first end 546.

Similar to the reversing mechanism 50, the pivoting bar 514 engages one of the projections 522a, 522b of the cage 66 to rotate the cage 66 relative to the barrel 70 to change the slip and drive directions between clockwise and counterclockwise rotational directions. The pivoting bar 514 is moveable between a forward position, in which the drive direction is clockwise, a reverse position, in which the drive direction is counterclockwise, and a neutral position. To tighten a fastener, a user may engage the first end 546 of the actuator plate 518 which pivots the pivoting bar 514 to the forward position. The second portion 538 of the pivoting bar 514 engages the projection 522a causing the cage 66 to rotate counterclockwise a small amount relative to the barrel 70 to position the rollers 74 adjacent a trailing end of the surfaces 86. In the forward position, when the yoke 42 rotates in a clockwise direction, the rollers 74 engage the inner surface 90 of the yoke 42 and the surfaces 86 of the barrel 70 to drive the barrel 70, and thus the anvil 106, in a clockwise direction to tighten a fastener. When the yoke 42 rotates in a counterclockwise direction, the rollers 74 slip along the surfaces 86 of the barrel 70, allowing the cage 66 to rotate relative to the barrel 70 without transferring torque to the anvil 106.

To loosen a fastener, a user may engage the second end 550 of the actuator plate 518 which pivots the pivoting bar 514 to the reverse position. The second portion 538 of the pivoting bar 514 engages the projection 522b causing the cage 66 to rotate clockwise a small amount relative to the barrel 70 to position the rollers 74 adjacent a leading end of the surfaces 86. In the reverse position, when the yoke 42 rotates in a counterclockwise direction, the rollers 74 engage the inner surface 90 of the yoke 42 and the surfaces 86 of the barrel 70 to drive the barrel 70, and thus the anvil 106 in a counterclockwise direction to loosen a fastener. When the yoke 42 rotates in a clockwise direction, the rollers 74 slip along the surfaces 86 of the barrel 70, allowing the cage 66 to rotate relative to the barrel 70 without transferring torque to the anvil 106.

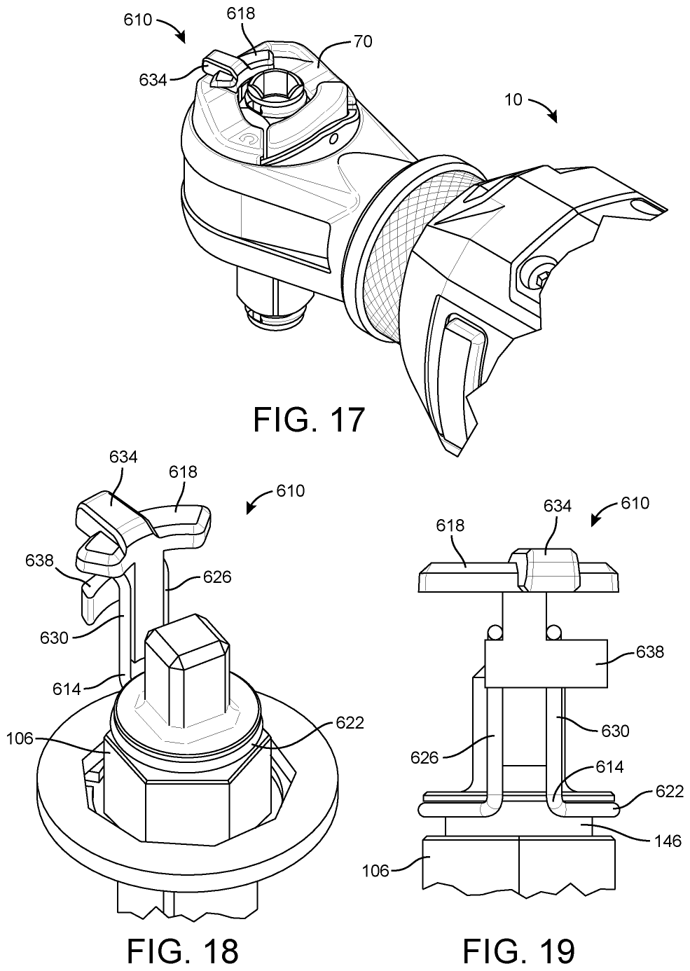

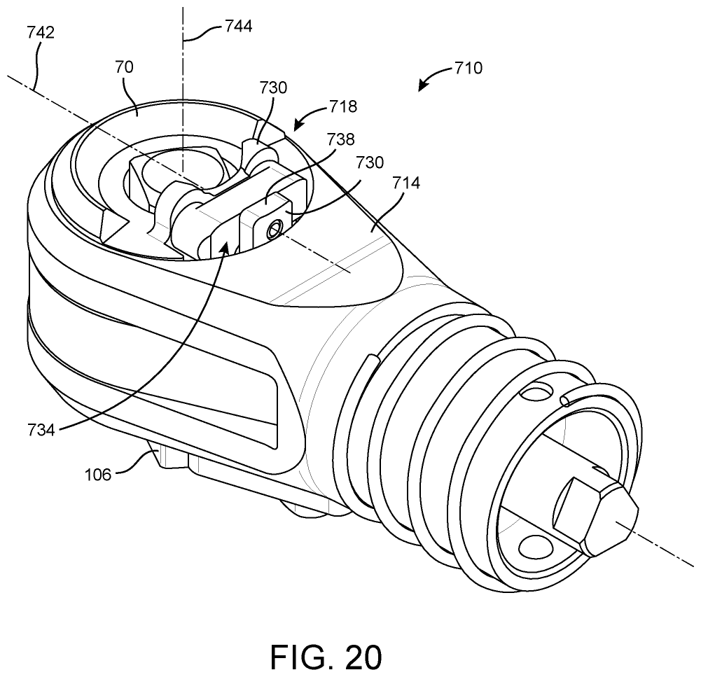

FIGS. 17-19 illustrate another embodiment of an anvil release mechanism 610 for use with the powered ratchet 10. The anvil release mechanism 610 is supported by the barrel 70 and includes a resilient locking member (i.e., an annular or ring-shaped spring 614) and an actuator 618. The ring-shaped spring 614 includes a loop portion 622, a first leg 626 extending from an end of the loop portion 622, and a second leg 630 extending from an opposite end of the loop portion 622. The loop portion 622 engages one of the grooves 146 of the anvil 106 to secure the anvil 106 to the barrel 70 for rotation therewith. The actuator 618 is coupled to the end of the first leg 626 of the ring-shaped spring 614. The actuator 618 includes a projection 634 that is accessible to a user and an arcuate guide plate 638. In the illustrated embodiment, a user may engage the projection 634 on the actuator 618 to move the first leg 626 relative to the second leg 630 to release the anvil 106 from the barrel 70. The guide plate 638 directs the movement of the actuator 618 in a circumferential direction. To release the anvil 106, a user may press the actuator 618 to move the first leg 626 of the ring-shaped spring 614 away from the second leg 630 causing the diameter of the loop portion 622 to expand which moves the loop portion 622 out of the groove 146 allowing the anvil 106 to be removed from the bore of the barrel 70. The ring-shaped spring 614 is inherently biased to a locked position, in which the loop portion 622 engages the groove 146 of the anvil 106 to secure the anvil 106 to the barrel 70. As such, when the user releases the actuator 618, the first leg 626 of the ring-shaped spring 614 returns to its original position. To recouple the anvil 106 to the barrel 70, a user may move the actuator 618 again to expand the diameter of the loop portion 622, allowing the anvil 106 to re-enter the bore of the barrel 70. Once the anvil 106 is in position, the user may release the actuator 618 allowing the first leg 626 to return to its original position and the loop portion 622 to re-engage one of the grooves 146 on the anvil 106.

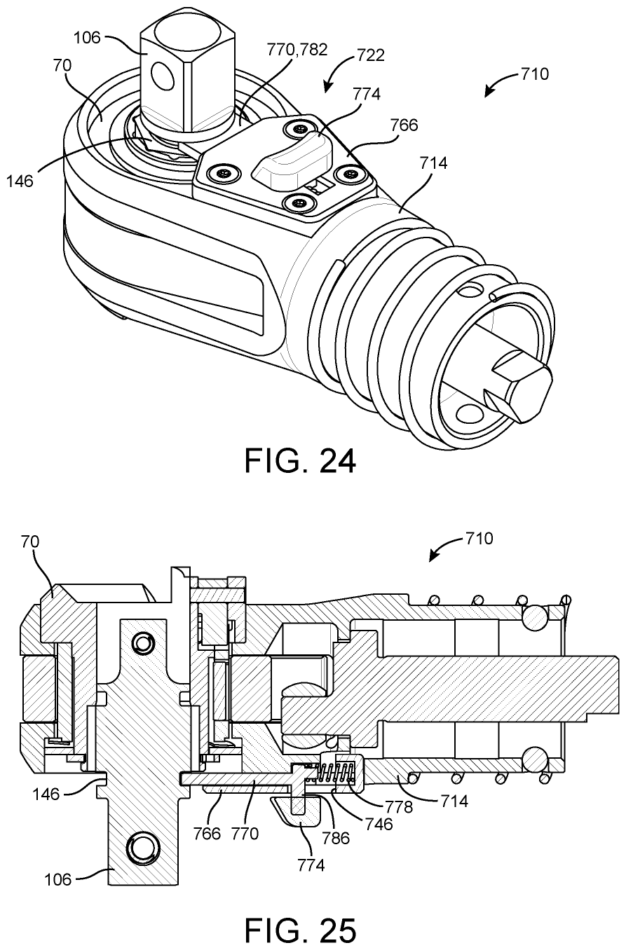

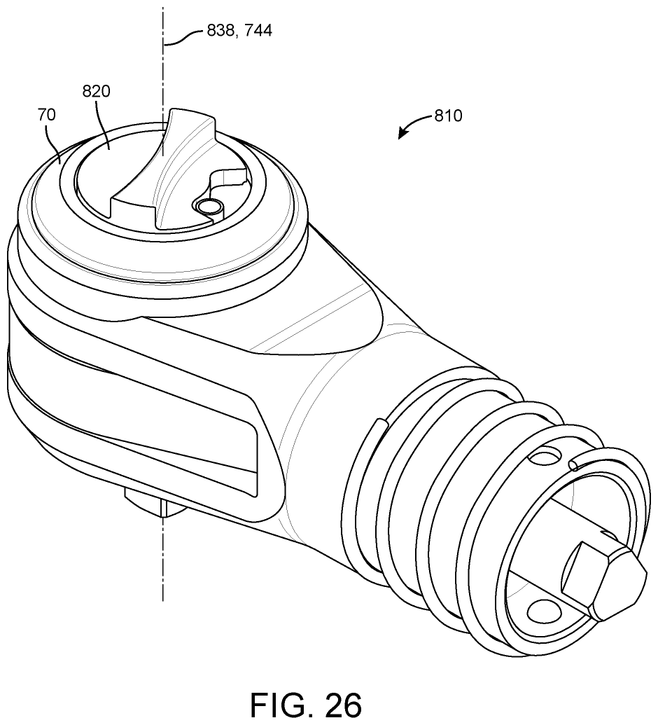

FIGS. 20-25 illustrate another embodiment of a drive unit 710 for use with the powered ratchet 10. The drive unit 710 is similar to the drive unit 26 discussed above with like features being represented with like reference numerals. The drive unit 710 includes a mounting portion 714 coupled to the housing 14, the yoke 42, a reversing mechanism 718, and an anvil release mechanism 722 (FIG. 24).

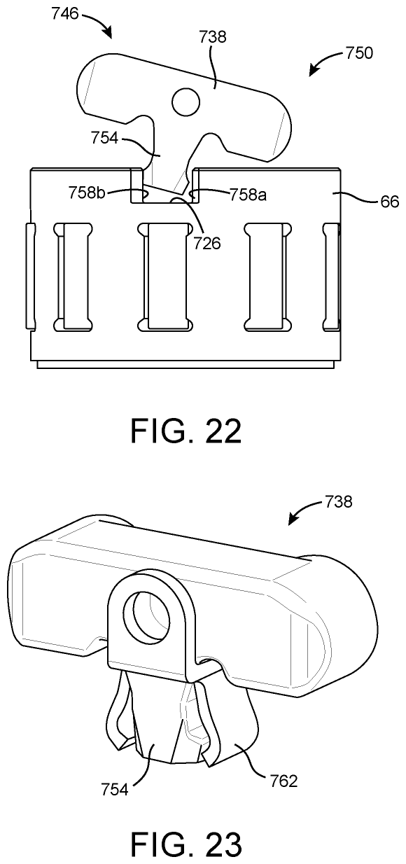

With reference to FIGS. 20-23, the reversing mechanism 718 is similar to the reversing mechanism 50 discussed above. However, instead of the posts 82, the cage 66 includes a recess 726 (FIG. 22) defined on an upper side and the barrel 70 includes two brackets 730 that define a space 734 therebetween. The reversing mechanism 718 also includes an actuator (e.g., a rocker 738) that is coupled to the two brackets 730 for pivotable movement within the space 734 about a pivot axis 742 that is perpendicular to a drive axis 744 of the anvil 106. With reference to FIG. 22, the rocker 738 includes a first end, a second end 750 opposite the first end 746, and a stem 754 that is positioned between inner sides 758a, 758b of the recess 726 defined in the cage 66. The rocker 738 is operable to switch the slip and drive directions of the clutch mechanism 46 between clockwise and counterclockwise directions.

To tighten a fastener, a user may engage the first end 746 of the rocker 738, which pivots the stem 754 to a forward position, in which the stem 754 engages the inner side 758a of the recess 726 causing the cage 66 to rotate counterclockwise a small amount relative to the barrel 70 to position the rollers 74 adjacent a trailing end of the surfaces 86. In the forward position, when the yoke 42 rotates in a clockwise direction, the rollers 74 engage the inner surface 90 of the yoke 42 and the surfaces 86 of the barrel 70 to drive the barrel 70, and thus the anvil 106, in a clockwise direction to tighten a fastener. When the yoke 42 rotates in a counterclockwise direction, the rollers 74 slip along the surfaces 86 of the barrel 70, allowing the cage 66 to rotate relative to the barrel 70 without transferring torque to the anvil 106.

To loosen a fastener, a user may engage the second end 750 of the rocker 738, which pivots the stem 754 to a reverse position, in which the stem 754 engages the inner side 758b of the recess 726 (FIG. 23), causing the cage 66 to rotate clockwise a small amount relative to the barrel 70 to position the rollers 74 adjacent a leading end of the surfaces 86. In the reverse position, when the yoke 42 rotates in a counterclockwise direction, the rollers 74 engage the inner surface 90 of the yoke 42 and the surfaces 86 of the barrel 70 to drive the barrel 70, and thus the anvil 106 in a counterclockwise direction to loosen a fastener. When the yoke 42 rotates in a clockwise direction, the rollers 74 slip along the surfaces 86 of the barrel 70, allowing the cage 66 to rotate relative to the barrel 70 without transferring torque to the anvil 106. As shown in FIG. 23, in some embodiments, the reversing mechanism 718 may include a leaf spring 762 positioned between the stem 754 and the inner sides 758a, 758b to apply a spring force to the cage 66 when alternating the drive direction.

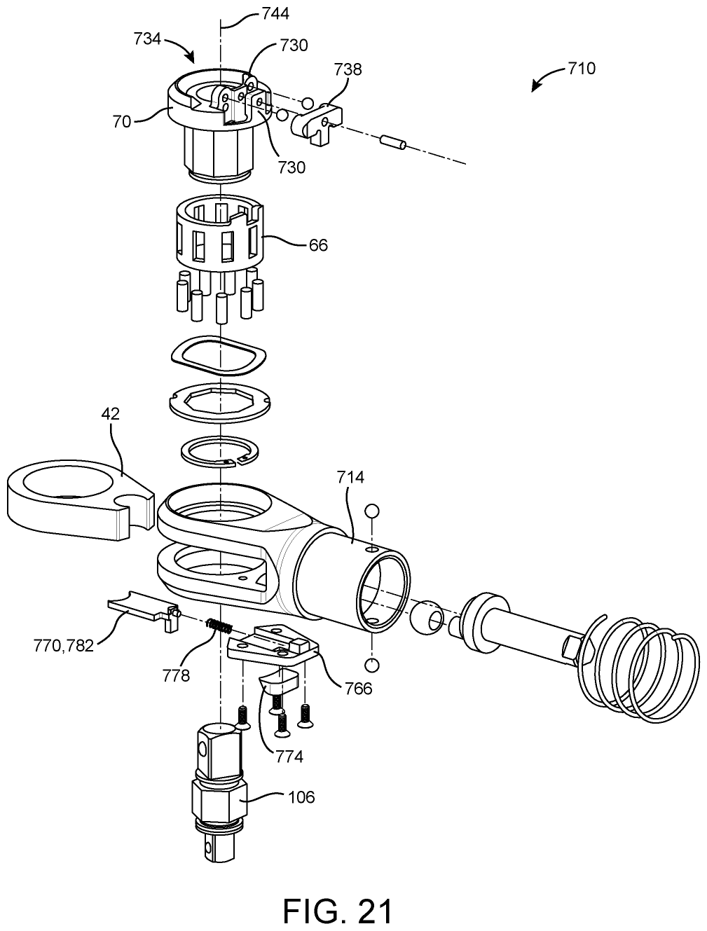

With reference to FIGS. 21, 24 and 25, the anvil release mechanism 722 is similar to the anvil release mechanism 54 described above. The anvil release mechanism 722 includes a cover 766, a locking member (i.e., sliding plate 770), an actuator 774, and a biasing member (e.g., a compression spring 778). The cover 766 is coupled to the mounting portion 714 with fasteners. The sliding plate 770 is slidably supported between the cover 766 and the mounting portion 714 to engage one of the two grooves 146 on the anvil 106. The sliding plate 770 includes an arcuate portion 782 that engages one of the grooves 146 and a projection 786 that extends through an opening 790 in the cover 766. The actuator 774 is coupled to the projection 786. The compression spring 778 biases the sliding plate 770 to a locked position, in which the arcuate portion 782 engages one of the grooves 146 in the anvil 106 to secure the anvil 106 to the barrel 70 for co-rotation therewith.

To release the anvil 106, a user may push the actuator 774 in a direction perpendicular to the drive axis 744 against the bias of the compression spring 778 to move the arcuate portion 782 out of engagement with the groove 146 allowing the anvil 106 to be removed from the bore of the barrel 70. Oppositely, to secure the anvil 106 to the barrel 70, a user may push the actuator 774 against the bias of the compression spring 778 allowing the anvil 106 to be inserted into the bore of the barrel 70. Once the anvil 106 is positioned within the bore, the user may release the actuator 774, allowing the compression spring 778 to bias the arcuate portion 782 into engagement with one of the grooves 146 on the anvil 106 to secure the anvil 106 to the barrel 70.

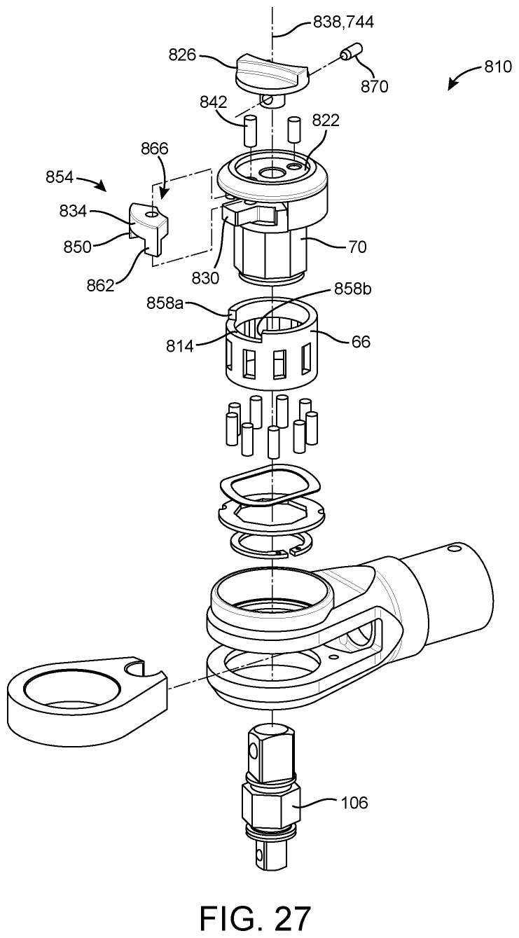

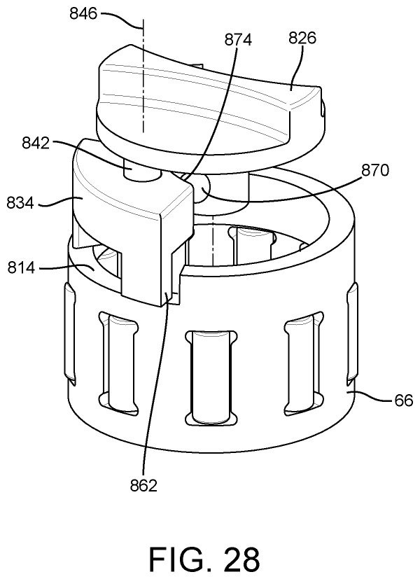

FIGS. 26-28 illustrate another embodiment of a reversing mechanism 810 for use with the powered ratchet 10. The reversing mechanism 810 is similar to the reversing mechanism 718 discussed above with like features being represented with like reference numerals. However, the cage 66 includes an elongated recess 814 on an upper side. In addition, the barrel 70 includes a recess 822 to receive knob 826 and a stem 830 that supports an actuator (i.e., a shift block 834). The knob 826 is rotatably coupled to the barrel 70 about a rotation axis 838 that is coaxial to the drive axis 744 of the anvil 106. The shift block 834 is pivotably supported on the stem 830 of the barrel 70 about a pin 842 that defines a pivot axis 846 (FIG. 28) that is parallel to the drive axis 744 of the anvil 106. The shift block 834 includes a first leg 850 at a first end 854 that engages an inner side 858a of the recess 814 and a second leg 862 at a second end 866 that engages an opposite inner side 858b of the recess 814. A pin detent 870 supported by the knob 826 is biased by a spring (not shown) to engage a rear side 874 of the shift block 834. The knob 826 is operable to switch the slip and drive directions of the clutch mechanism 46 between clockwise and counterclockwise directions.

To tighten a fastener, a user may rotate the knob 826 about the rotation axis 838 in a clockwise direction causing the pin detent 870 to move towards the first end 854 of the shift block 834 which pivots the shift block 834 to a forward position. In the forward position, the second leg 862 of the shift block 834 engages the inner side 858b of the elongated recess 814, causing the cage 66 to rotate counterclockwise a small amount relative to the barrel 70 to position the rollers 74 adjacent a trailing end of the surfaces 86. In the forward position, when the yoke 42 rotates in a clockwise direction, the rollers 74 engage the inner surface 90 of the yoke 42 and the surfaces 86 of the barrel 70 to drive the barrel 70, and thus the anvil 106, in a clockwise direction to tighten a fastener. When the yoke 42 rotates in a counterclockwise direction, the rollers 74 slip along the surfaces 86 of the barrel 70, allowing the cage 66 to rotate relative to the barrel 70 without transferring torque to the anvil 106.

To loosen a fastener, a user may rotate the knob 826 in a counterclockwise direction causing the pin detent 870 to move towards the second end 866 of the shift block 834 which pivots the shift block 834 to a reverse position. In the reverse position, the first leg 850 of the shift block 834 engages the inner side 858a of the elongated recess 814, causing the cage 66 to rotate clockwise a small amount relative to the barrel 70 to position the rollers 74 adjacent a leading end of the surfaces 86. In the reverse position, when the yoke 42 rotates in a counterclockwise direction, the rollers 74 engage the inner surface 90 of the yoke 42 and the surfaces 86 of the barrel 70 to drive the barrel 70, and thus the anvil 106 in a counterclockwise direction to loosen a fastener. When the yoke 42 rotates in a clockwise direction, the rollers 74 slip along the surfaces 86 of the barrel 70, allowing the cage 66 to rotate relative to the barrel 70 without transferring torque to the anvil 106.

Various features and advantages are set forth in the following claims.

1. A powered ratchet comprising:
a motor;
a mounting portion;
an output member configured to rotate in response to activation of the motor, the output member defining a drive axis; and
a release mechanism configured to selectively couple an anvil to the output member, the release mechanism including
a cover coupled to the mounting portion and including a track,
a locking member positioned between the mounting portion and the cover and operable to slide within the track between a locked position, in which the locking member engages the anvil to secure the anvil to the output member for co-rotation therewith, and a release position, in which the locking member is disengaged from the anvil to facilitate removal of the anvil, and
a biasing member biasing the locking member to the locked position.

2. The powered ratchet of claim 1, wherein the locking member is an arcuate fork including two prongs.

3. The powered ratchet of claim 1, wherein the release mechanism further includes a slide actuator coupled to the locking member and operable to move the locking member between the locked position and the release position.

4. The powered ratchet of claim 3, wherein the locking member moves linearly between the locked position and the release position.

5. The powered ratchet of claim 1, further comprising:
a yoke defining a central opening, the output member positioned within the central opening; and
a cage positioned between the yoke and the output member, the cage including a plurality of openings, each opening configured to receive a roller.

6. A powered ratchet comprising:
a motor
an output member configured to rotate in response to activation of the motor, the output member defining a drive axis; and
a release mechanism configured to selectively couple an anvil to the output member, the release mechanism including
a locking member pivotable between a locked position, in which the locking member engages the anvil to secure the anvil to the output member for co-rotation therewith, and a release position, in which the locking member is disengaged from the anvil to facilitate removal of the anvil from the output member,
a slider that is moveable between a forward position, in which the slider locks the locking member in the locked position, and a rearward position, in which the locking member is allowed to pivot between the locked position and the release position, and
a biasing member configured to bias the slider to the forward position.

7. The powered ratchet of claim 6, wherein either the locking member or the slider includes a tang, and wherein the other of the locking member or the slider includes a recess to receive the tang when the locking member is in the locked position.

8. The powered ratchet of claim 6, wherein the locking member is biased to the locked position.

9. The powered ratchet of claim 6, wherein the locking member is biased to the release position.

10. The powered ratchet of claim 6, wherein the slider moves linearly between the forward position and the rearward position.

11. The powered ratchet of claim 6, wherein the release mechanism further includes an actuator coupled to the slider to move the slider between the forward position and the rearward position.

12. The powered ratchet of claim 6, further comprising:
a yoke defining a central opening, the output member positioned within the central opening; and
a cage positioned between the yoke and the output member, the cage including a plurality of openings, each opening configured to receive a roller.

13. A powered ratchet comprising
a motor;
an output member configured to rotate in response to activation of the motor, the output member defining a drive axis; and
a release mechanism configured to selectively couple an anvil to the output member, the release mechanism including
a resilient locking member moveable between a locked position in which the locking member engages the anvil to secure the anvil to the output member for co-rotation therewith, and a release position, in which the locking member is disengaged from the anvil to facilitate removal of the anvil from the output member, and
an actuator coupled to the locking member to move the locking member between the locked position and the release position.

14. The powered ratchet of claim 13, wherein the locking member is an annular spring.

15. The powered ratchet of claim 13, wherein the locking member is biased to the locked position.

16. The powered ratchet of claim 13, wherein the locking member includes a loop portion, a first leg extending from an end of the loop portion, and a second leg extending from an opposite end of the loop portion.

17. The powered ratchet of claim 16, wherein movement of the locking member between the locked position and the release position increases the diameter of the loop portion to release the anvil.

18. The powered ratchet of claim 16, wherein the actuator is coupled to the first leg.

19. The powered ratchet of claim 13, wherein the actuator moves in a circumferential direction to move the locking member from the locked position to the release position.

20. The powered ratchet of claim 13, further comprising:
a yoke defining a central opening, the output member positioned within the central opening; and
a cage positioned between the yoke and the output member, the cage including a plurality of openings, each opening configured to receive a roller.

21.-51. (canceled)
